(19) United States
(12) Patent Application Publication
(10) Pub. No.: US 2006/0038373 A1
(43) Pub. Date: Feb. 23, 2006

(54) Pedal scooter

(76) Inventor: Volker von Detten, El Segundo, CA (US)

Correspondence Address: VOLKER VON DETTEN, 535 E. WALNUT AVE. # A, EL SEGUNDO, CA, 90245, US

(21) Appl. No.: 11/210,342

(22) Filed: Aug. 23, 2005

Related U.S. Application Data
(60) Provisional application No. 60/603,952, filed on Aug. 23, 2004.

(51) Int. Cl. B62M 1/00

(52) U.S. Cl. 280/221

(57) ABSTRACT

A pedal scooter comprises a chassis with a platform in horizontal plane with at least one steerable front wheel attached in vertical plane and at least one rear traction wheel attached in vertical plane. Rear traction wheel has a drive sprocket gear rotationally mounted with a ratchet mechanism coupled to traction wheel. At least one reciprocating pedal is pivotally mounted to chassis with a pivot element to be situated to part a forward portion of pedal with a foot engaging section from a rearward portion of pedal with a foot engaging section in approximation below a hinged connection between forward section and rear ward section retrospectively. Distal end of forward section of pedal has attached to it another pivotal element engaging a link downwardly directed and engaging with the opposing end to a telescoping apparatus mounted in a horizontal plane along longitudinal centerline of chassis. Distal end of telescoping apparatus is connected to a chain loop encircling and engaging with drive sprocket gear. Chain loop is terminating to a cable return loop encircling an idler pulley with an element for applying a tensile force to chain. Reciprocating action of rearward and forward pedal retrospectively transfers a movement in vertical plane to a movement in horizontal plane with telescoping apparatus retracting and expanding displacing drive chain about drive sprocket gear and compelling traction wheel to turn in clockwise directing for propulsion of scooter. The ratchet mechanism permits the drive sprocket gear propulsion of traction wheel and scooter in proper direction with freewheeling in the opposite direction.

### RELATED APPLICATIONS

This application claims the priority date of a prior filed application having Ser. No. 60/603,952 and filing date of Aug. 23, 2004 and entitled: Scooter without motorized assistance or operator's foot pushing against riding surface to accelerate scooter forward.

### BACKGROUND OF THE INVENTION

1. Incorporation by Reference

Applicant(s) herein incorporate by reference, any and all U.S. patents and U.S. patent applications cited or referred to in this application.

2. Field of Invention

This invention relates generally to scooters in particular to a scooter including the arrangement of elements to form a drive mechanism to enable the scooter to propel in forward motion providing a scooter passenger activates the drive mechanism.

### BACKGROUND

A conventional and common scooter comprises a frame or chassis, which has a mounted platform in a horizontal plane whereby the chassis, is joined to a steer able front wheel at one end mounted in vertical plane and to a rear traction wheel at the opposing end mounted in vertical plane. Front wheel is connected to an upright steering column with a handle bar mounted to the upper end of steering column. The scooter passenger stands with one foot on the platform simultaneously gripping opposing ends of handle bar with the left and right hand accordingly whereby the other foot of scooter passenger repeatable pushes in angular direction against the ground with the objective to push scooter forward and set it in propulsive mode. Certain limitations of described scooter are manifested by scooter's inefficiency in that an increase in forward motion requires that the propelling foot must be pushed in opposite direction of direction scooter motion at a greater speed than movement of scooter for at least maintaining and increasing forward propulsion of scooter. Therefore increasing forward propulsion of scooter is entirely dependent on the ability of the propelling foot of scooter passenger to push scooter forward efficiently in continuous fashion. It is known this to be tiresome requiring considerable strength and physical endurance of scooter passenger.

More recently motorized versions of scooters have become available for the use of older children and adults. Although they may have the advantage of greater propulsion and physical convenience they also tend to be noisy, may cause a safety hazard to the rider and other people and needs to carry flammable fuel for continued propulsion. An alternate version is the electrical motorized version, which requires carrying along bulky batteries, which at most have a limited supply of electricity to maintain propulsion of scooter.

Various designs of scooter propulsion devices have been invented. Many of these inventions have been dedicated to self powered scooters enabling the scooter passenger to accelerate in propulsion without the need of direct engagement with scooter passenger's foot and the ground scooter is riding on. Some of these scooters are propelled by means of pedal others by means of cranks and then others by means of body motions by the scooter passenger.

### DESCRIPTION OF RELATED ART

The following art describes the present state of this field:

U.S. Pat. No. 1,750,187 to Miller, Platt describes a pedal scooter comprising a chassis with a platform in horizontal plane situated between steer able front wheel in vertical plane and traction rear wheel mounted in vertical plane. The platform supports a reciprocating pedal with a bracket for pivotal mounting of said pedal. The end portion of pedal directed towards said front wheel has a foot engaging area for scooter passenger wherein the rear portion directed towards said rear traction wheel has a foot engaging area. Pivotal mount for said pedal is situated whereby front portion of pedal is of equal length to rear portion of said pedal. Underside of said rear portion of said pedal is connected to a rearward-extended link having a transverse flange, which is secured to platform. Said link has an elongated slot in which works a pivotal element imparting rotation to a pawl wheel via reciprocating motion of said pedal by one foot of said passenger riding said scooter depressing said rear portion of said pedal whereby the other foot resting on said front end portion of said pedal will depress said front end portion of said pedal downwardly setting said pawl into rotational motion subsequently turning said traction wheel in clock wise direction. Said invention teaches the complete utilization of reciprocating movement in specific the depressing of said rear portion of said pedal by said one foot of said passenger which after completion to be immediately followed by depressing said front-end portion of said pedal by said other foot of said passenger of said scooter to be transmitted into a continuous application of torque momentum onto said rear traction wheel of scooter. Said invention also teaches the ability of said scooter to free wheel for coasting down hill. Said invention does not teach how propulsion can be accomplished for obtaining a reasonable forward speed of said scooter whereby the reciprocating effect of said pedal may not be adequate transmitting via said pivotal element and said pawl wheel a reasonable number of clock wise revolutions of said traction rear wheel for each completed down ward stroke of said pedal. Said rear traction wheel may be required to be of much greater circumference for achieving a substantially greater in length linear motion for enabling said scooter to propel at greater speed. It is note worthy to mention that aforesaid accommodations in design of said scooter would require a greatly larger in size and bulkier in weight scooter whereby propulsion at a reasonable speed maintains to be less than desirable. Further more distance of platform to ground level would be greatly increased directly impacting stability of scooter when in motion.

U.S. Pat. No. 2,723,131 to McChescney, Jr. describes a pedal scooter comprising of a chassis with a platform in horizontal plane situated between a steerable front wheel in vertical plane and a traction rear wheel mounted in vertical plane. Said platform supports a reciprocating pedal with a bracket for pivotal mounting of said pedal. End portion of said pedal directed towards said front wheel has a foot engaging area for scooter passenger wherein the opposite end portion of said pedal is connected with a link to a geared rack said rack engaging with its opposite end portion a drive sprocket gear mounted on an axle shaft supporting said traction wheel and immediately adjacent to said traction wheel said drive sprocket gear is connected to a one uni directional ratchet clutch said uni directional ratchet clutch being rigidly connected to said traction rear wheel. Down ward motion of front end of pedal caused by foot of scooter passenger engaging with said foot engaging area and depressing said pedal is causing said lever arm to raise upwardly wherein said geared rack is pulled forward in linear fashion causing sprocket gear to turn in clockwise rotation about said drive axle effectively causing clock wise rotation of said traction rear wheel thereby propelling said scooter into forward motion. Said link may be required to be of much greater length in vertical plane for achieving a substantially greater in length linear motion of said gear rack whereby said gear rack would have to be of greater length also retrospectively for enabling said scooter to propel into a greater forward motion. It is note worthy to mention that aforesaid accommodations in design of said scooter would require a greatly larger in size and bulkier in weight scooter whereby propulsion at a reasonable forward motion maintains to be less than desirable. Further more distance of said platform to ground level would be greatly increased directly impacting stability of said scooter when in forward motion.

U.S. Pat. No. 1,601,249 to Hayden describes a pedal scooter comprising of a chassis situated between steer able front wheel in vertical plane and traction rear wheel mounted in vertical plane. Said chassis supports a pair of reciprocating pedal with a pivotal mounting of said pair of pedal at the forward extremity of said pair of pedal to chassis member of said chassis whereby a pair of torsion spring is attached to upper side of said chassis member in vertical plane as such interposed between said chassis member and underside of said pedal. Opposing end of said pair of pedal to said pivotal attachment has attached to it a pair of radial configured gear rack in vertical plane directly opposed and engaging rear portion of said pair of pedal by left and alternatively right foot of scooter passenger with said pair of torsion spring to reposition said pedal in upward position after completion of preceding said down ward stroke by releasing down ward pressure by said foot of said scooter passenger. Said invention teaches the complete utilization of reciprocating movement in specific the depressing of said pair of pedal in alternate fashion whereby a continuous application of torque momentum onto said rear traction wheel of said scooter is transmitted. Said invention also teaches the ability of said scooter to free wheel for coasting down hill. Said invention does not teach how propulsion can be accomplished for obtaining a reasonable forward speed of said scooter whereby the reciprocating effect of said pair of pedal may not be adequate transmitting via said geared rack, pinion a reasonable number of clock wise revolutions of said traction rear wheel for each completed down ward stroke of said pedal. It is noteworthy to mention that engagement arrangement of a rack with said pinion in a vertical plane is limited in length by the available ground clearance to axle shaft of said traction wheel. Therefore said scooter may have to be equipped with greatly enlarged said traction wheel in circumfence to enable for said scooter to maintain reasonable forward propulsion. Further more distance of said platform to ground level would be greatly increased directly impacting stability of said scooter when in motion.

U.S. Pat. No. 6,270,102 to Chee Keung Fan describes a pedal scooter comprising of a chassis with a platform in horizontal plane situated between steer able front wheel in vertical plane and traction rear wheel mounted in vertical plane. Said platform supports a reciprocating pedal with a bracket for pivotal mounting of said pedal whereby the end portion of said pedal directed towards said front wheel has a foot engaging area for scooter passenger connected to a linkage to a primary sprocket rear with an endless chain loop whereby said primary sprocket gear is rotational mounted to the underside of said platform of said scooter. Said endless chain loop engages a pinion gear mounted relatable to the axle shaft of said traction rear wheel immediately adjacent to said traction rear wheel and permanently connected to a ratchet type clutch arrangement. By depressing said pedal downwardly said linkage is forcing primary sprocket gear into counter clock wise rotation to displace a portion of said chain loop causing said pinion gear with said traction wheel to rotate in clock wise direction to put said scooter in forward motion. Another embodiment of said invention shows an arrangement for set of gears with another drive link between said primary sprocket and said pinion gear which objective is to increase the gear ration for the purpose to enable said scooter to propel forward at greater speed. Said invention teaches the application of a reciprocating pedal pivotally attached for the purpose of transmitting and converting reciprocating motion into rotational motion to enable to set said scooter into forward propulsion. Said invention also teaches the ability of said scooter to free wheel for coasting down hill. Said invention does not teach how propulsion can be accomplished for obtaining a reasonable forward speed in propulsion of said scooter whereby the reciprocating effect of said reciprocating pedal may not be sufficient in transmitting via said chain loop, pinion a reasonable number of clock wise revolutions to said traction rear wheel for each completed down ward stroke of said pedal. It is noteworthy to mention that engagement arrangement of a primary gear sprocket, endless chain loop with said pinion in a vertical plane is limiting the outer circumfence of said primary sprocket to the available ground clearance to axle shaft of said traction wheel and said steer able front wheel in retrospect.

U.S. Pat. No. 6,688,624 B2 to Christensen, Ghiz, Perryman describes a pedal scooter comprising a chassis with a platform in horizontal plane between steer able front wheel in vertical plane and traction rear wheel mounted in vertical plane. The platform supports a reciprocating and pivotally mounted crank whereby the end portion of crank directed towards said front wheel has a foot engaging pivotally mounted pedal for scooter passenger. Opposing end portion of said crank consists of a radially configured gear rack engaging with a primary sprocket gear mounted rotational in coaxial fashion with axle shaft of said traction wheel. Immediately adjacent to said primary sprocket gear and immediately adjacent to said traction wheel at opposing side of said primary sprocket gear is a further sprocket gear mounted rotational and attached to said axle shaft which also has mounted said rotationally and permanently attached said primary sprocket gear encircled by an endless chain loop whereby said endless chain loop engages with a drive sprocket gear rotationally and permanently attached to a drive shaft whereby said drive shaft is attached to a chassis extension reaching at a slightly upwardly directed and angular position beyond the outer extremity of traction wheel. Opposing end of said drive shaft has permanently and rotationally attached a further sprocket gear encircled yet by another endless chain loop whereby said endless chain loop engages at the opposing end with a second drive sprocket gear rotational mounted and permanently attached to said axle shaft of traction wheel. When foot of scooter passenger depresses said foot engaging portion mounted pivotally on said crank said gear rack rotates primary sprocket gear whereby said sprocket gear displaces a portion of said chain loop causing said drive sprocket gear to rotate with said drive shaft and said drive sprocket gear at opposing end of said drive shaft with said further chain loop transmitting rotation to said drive sprocket permanently attached to axle of said traction wheel and rotate said traction wheel in clockwise direction. A further embodiment of said invention describes a reciprocating and pivotally mounted crank whereby the end portion of said crank directed towards said rear traction wheel has a foot engaging pivotally mounted pedal for scooter passenger. Opposing end portion of said crank comprises a radially configured gear rack engaging with a primary gear mounted rotational on an auxiliary axle in slightly angular and rearward position beyond outer extremity of steering wheel of said scooter. Permanently attached to said primary gear and said auxiliary axle is a drive gear engaging with a second drive gear mounted rigidly and rotational on a second drive shaft whereby said second drive shaft has a rigidly and rotationally mounted drive sprocket gear encircled by an endless chain loop reaching fully along said platform of said scooter engaging with a second drive sprocket permanently attached to said axle shaft supporting said traction wheel and immediately adjacent to said traction wheel said drive sprocket gear is connected to a uni directional ratchet clutch said uni directional ratchet clutch being rigidly connected to said traction rear wheel. Said invention and embodiments as shown teach the application of a series of transmissionally arranged gears, endless chain loop, pinion and gear rack for the purpose of achieving a gear ratio for said scooter to obtain a sufficient enough forward propulsion in speed when scooter passenger is operating said reciprocating pedal. Said invention also teaches the ability of said scooter to free wheel when coasting down hill. Said invention does not provide for proper consideration of ergonomic aspects to operate said scooter efficiently and with a minimum of physical strength and out put. As shown one embodiment encompasses the foot pedal portion of said reciprocating crank at the rear section of said scooter and at considerable vertical elevation above platform of said scooter. Therefore it becomes difficult to operate said scooter for one reason that said scooter passenger must be able to apply down ward pressure with foot engaging area of said reciprocating crank without having provisions to brace other foot to provide needed counter action and body balance for a relative effort less completion of downward stroke of said reciprocating crank. Also more intense downwardly directed pressure to said foot engaging area of said rotational attached pedal like wise to be experienced in competitive speed contests and other like situations, may concentrate a majority of body weight of said scooter passenger towards the furthest rear section of said scooter which means that counter action by said scooter passenger may be applied to steering bar above front steering wheel for the purpose to accelerate downward stroke beyond just body weight application thereby at that time element the gravitational point is transferred towards and may be coaxial with axle shaft of said traction wheel thereby reducing traction of front steering wheel of said scooter in effect said scooter may become greatly unstable and may cause eventually great harm to said scooter passenger by collapsing onto ground. Said embodiment of said invention does not teach said scooter to be less bulky considering the great elevation distance of said rotational mounted foot engaging pedal from upper surface of said platform and a great number of said gear and chain loop extending beyond the traction wheel outer periphery. Said further embodiment of said invention fails to teach that for the purpose to increase gear ratio to enable said scooter to obtain greater forward speed in propulsion may not eliminate greatly the large ground clearance required for avoidance of surface irregularities the like of objects holes and other debris commonly dispersed. Further more a great distance of said platform to said ground level directly impacts stability of said scooter when in motion in addition to a greater weight, bulkiness, unsightliness and expense of said scooter. Also said endless chain loop extending along the complete length of said platform in vertical plane limits said scooter passenger ability to access platform freely and safely to a great degree in as much that said scooter passenger may be unable to perform certain semi acrobatics the like of skate board riders and to be of great popularity among young people.

U.S. Pat. No. 6,398,244 to Hung-Che Chueh shows a propelling scooter with a pivotally mounted reciprocating pedal converting reciprocating motion through a series of primary and secondary sprocket gear engaging with endless chain loop to enable a continuous rotational motion transmitted to a rear traction wheel of said scooter. An extended and endless chain loop with said primary and secondary gear sprocket require scooter platform to be of high ground clearance causing said scooter to be of unstable ride performance. Also said scooter requires large traction wheel and a considerable stroke length of said reciprocating pedal to gain appreciable speed in forward propulsion.

U.S. Pat. No. 6,572,128 to Graf describes a scooter with propulsion system for retrofit applied to common scooters without an independent propulsion system. Said retrofit shows a reciprocating pedal pivotally mounted onto top surface of scooter chassis. One side of said pedal shows a permanently to said pedal attached bracket with a pivotally mounted gear rack reaching along pedal to engage with a pinion mounted relatable and permanent to a support axle shaft of a traction rear wheel immediately adjacent to one side of said traction rear wheel and permanently connected to a ratchet type clutch arrangement enabling said gear rack to transmit clock wise rotational movement to said rear traction wheel of said scooter by means of reciprocating movement of pedal activated by depressing foot engaging area provided at end portions of said pedal. Down ward stroke of said pedal may result in less than one single revolution of said traction wheel due to the radial motion of pivot mount to be centered at said pivot fulcrum for said reciprocating pedal reducing a linear forward motion of said gear rack to the cosine in variance to angular position between fully extended upward position of said reciprocating pedal and fully depressed position of said reciprocating pedal. Therefore the end result is that said scooter may be unable to travel at any appreciable forward propulsive speed. Also said gear rack extending along a considerable length of said reciprocating pedal limits said scooter passenger ability to access platform freely and safely at a great degree in as much that said scooter passenger may be unable to perform certain semi acrobatics the like of skate board riders and to be of great popularity among young people.

U.S. Pat. No. 6,857,648 to Melmet describes a pedal scooter having one reciprocating pedal pivotally mounted to a frame of said scooter about a pedal axis and with a foot engaging area at end portion of said pedal. Underside of said pedal has attached to it a radially arranged gear rack engaging with a primary gear mounted in vertical plane on one side of chassis of said scooter. A fly wheel is mounted for rotation in vertical plane on one side of said frame with a one way drive connection between the reciprocating pedal and said fly wheel and between said fly wheel and said rear traction wheel of said scooter. It is noteworthy to mention that engagement arrangement of said flywheel with said gear rack in a vertical plane is limited in length by the available ground clearance to said axle shaft of said traction wheel. Therefore said scooter may have to be equipped with greatly enlarged traction wheel in circumfence to enable for said scooter to maintain a reasonable propulsion speed. Further more distance of platform to ground level would be greatly increased directly impacting stability of scooter when in motion. Further more said flywheel may affect stability of ride due to the gyroscopic effect said flywheel more likely when banking or turning said scooter.

U.S. patent application publication 2004/0036249A1 to McGuire, Saiki describes a pedal driven propulsion system with incorporation of a foot pedal pivotally mounted on scooter chassis whereby opposite end of foot engaging end portion of said pedal is connected via a linkage to a chain loop engaging with an idler sprocket gear and encircling a drive sprocket gear mounted permanently on axle shaft of a traction wheel immediately adjacent to said traction wheel of said scooter whereby chain terminates and is connected to a torsion spring mounted along side of said scooter chassis for the purpose to maintain tension on said chain loop. Opposing end of said chain loop is attached to a chassis member of said scooter. Downward pressure on foot engaging portion of said pedal pivots said linkage upwardly causing said idler sprocket to displace a portion of said chain loop causing said drive sprocket to rotate in clock wise direction in tandem with said traction wheel. As described in said publication said scooter might require a large traction wheel and a considerable stroke length of said reciprocating pedal to gain appreciable forward propulsion of said scooter. Further more said idler sprocket is arranged in a fashion not taking optimum opportunity of available reciprocating movement range of said pedal to the benefit of gaining an appreciable forward propulsion of said scooter. Also distance of said platform to ground level would be greatly increased directly impacting stability of said scooter when in motion.

My prior art search with abstracts described above teaches: several scooters including a design, but fails to teach a scooter with a mechanism to propel forward which combines a reciprocating motion apparatus with a linear telescope like apparatus to gain forward propulsion at a rapid pace without additional gears and the like. The present invention fulfills these needs and provides further related advantages as described in the following summary.

### SUMMARY OF INVENTION

The present invention teaches certain benefits in construction and use, which give rise to the objectives described below.

A pedal scooter comprises a chassis with a platform in horizontal plane with at least one steerable front wheel attached in vertical plane and at least one rear traction wheel attached in vertical plane. Rear traction wheel has a drive sprocket gear rotationally mounted with a ratchet mechanism coupled to traction wheel. At least one reciprocating pedal is pivotally mounted to chassis with a pivot element to be situated to part a forward portion of pedal with a foot engaging section from a rearward portion of pedal with a foot engaging section in approximation below a hinged connection between forward section and rear ward section retrospectively. Distal end of forward section of pedal has attached to it another pivotal element engaging a link downwardly directed and engaging with the opposing end to a telescoping apparatus mounted in a horizontal plane along longitudinal centerline of chassis. Distal end of telescoping apparatus is connected to a chain loop encircling and engaging with drive sprocket gear. Chain loop is terminating to a cable return loop encircling an idler pulley with an element for applying a tensile force to chain. Reciprocating action of rearward and forward pedal retrospectively transferees a movement in vertical plane to a movement in horizontal plane with telescoping apparatus retracting and expanding displacing drive chain about drive sprocket gear and compelling traction wheel to turn in clockwise directing for propulsion of scooter. The ratchet mechanism permits the drive sprocket gear propulsion of traction wheel and scooter in proper direction with freewheeling in the opposite direction.

A primary objective of one embodiment of the present invention is to provide an apparatus and method of use of such apparatus that yields advantages not taught by the prior art.

A still further objective is to assure that an embodiment of the invention is to provide a foot operated mechanism for a scooter to compel forward motion.

A still further objective is to assure that an embodiment of the invention is to provide a telescoping element for propelling a scooter in forward motion.

A still further objective is to assure that an embodiment of the invention is to provide a simple endless chain and cable loop to compel clockwise directional turning of traction wheel of a scooter.

A still further objective is to assure that an embodiment of the invention is capable of propelling a scooter in forward motion at a distance over a reasonable small time increment.

A still further objective is to assure that an embodiment of the invention is adaptable to various speed capabilities of a scooter fitting to terrain and riding surface and physical capability of a scooter passenger.

A still further objective is to assure that an embodiment of the invention is to provide minimum impairment to foot access to platform and pedal apparatus and low point of gravity of a scooter for stable and safe riding comfort to scooter passenger.

A still further objective is to assure that an embodiment of the invention is of a configuration that all transmission elements of a scooter are fully enclosed to the benefit of stream lined appearance and safe operation.

A still further objective is to assure that an embodiment of the invention is capable to provide various pedal element configuration of a scooter with convenient adjusting and exchange of dependent elements.

A still further objective is to assure that an embodiment of the invention is of a configuration that it can be manufactured cheaply, efficiently and to good quality standards.

Other features and advantages of the embodiments of the present invention will become apparent from the following more detailed description, taken in conjunction with the accompanying drawings, which illustrate, by the way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a side elevation view of a preferred embodiment of present invention of a foot operated reciprocating pedal in upward position with linkage connected to a telescope element mounted on chassis of a scooter with connection to a chain loop.

FIG. 2 is a top elevation view taken along lines 2-2 respectively in FIG. 1;

FIG. 3 is a side elevation view of a preferred embodiment of present invention of a foot operated reciprocating pedal in downward position with linkage connected to a telescope element mounted on chassis of a scooter with connection to a chain loop.

FIG. 4 is a top plan view taken along lines 4-4 respectively in FIG. 3;

FIG. 5 is a perspective and partially exploded view taken along lines 5-5 respectively in FIG. 4;

FIG. 6 is a perspective and exploded view of a preferred embodiment of present invention;

FIG. 7 is a perspective and partially exploded view taken along lines 7-7 respectively in FIG. 4;

FIG. 8 is a perspective and partially exploded view of a preferred embodiment of present invention;

### DETAILED DESCRIPTION OF THE INVENTION

The above-described drawing figures illustrate the present invention in at least one of its preferred, best mode embodiments, which are further, defined in detail in the following description. Those having ordinary skill in the art may be able to make alterations and modifications in the present invention without departing from its spirit and scope. Therefore it must be understood that the illustrated embodiments have been set forth only for the purposes of example and that they should not be taken as limiting the invention as defined in the following.

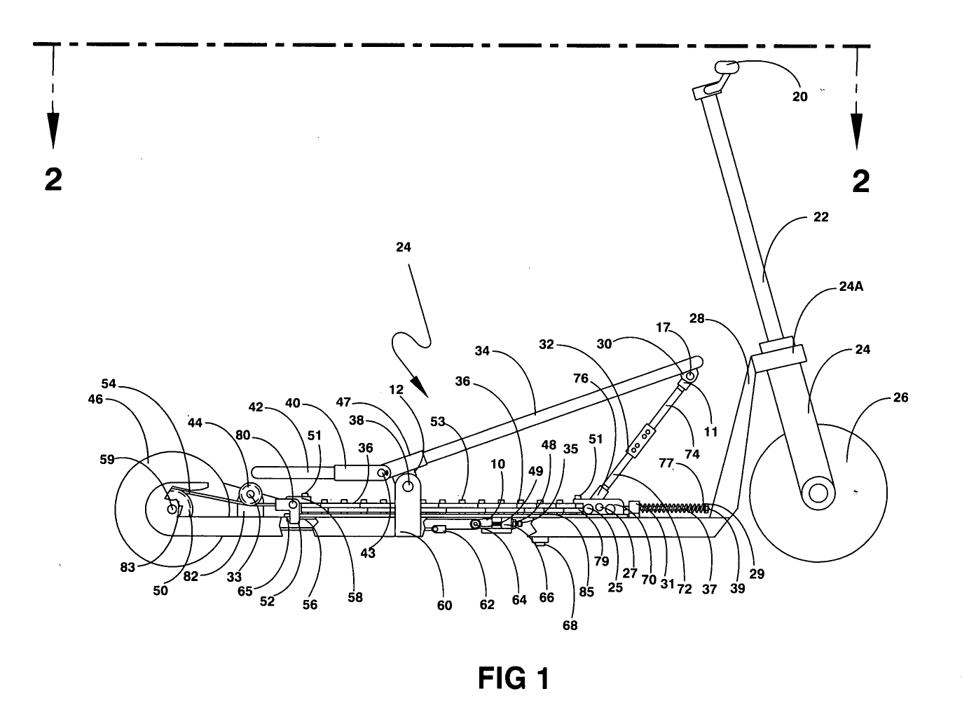

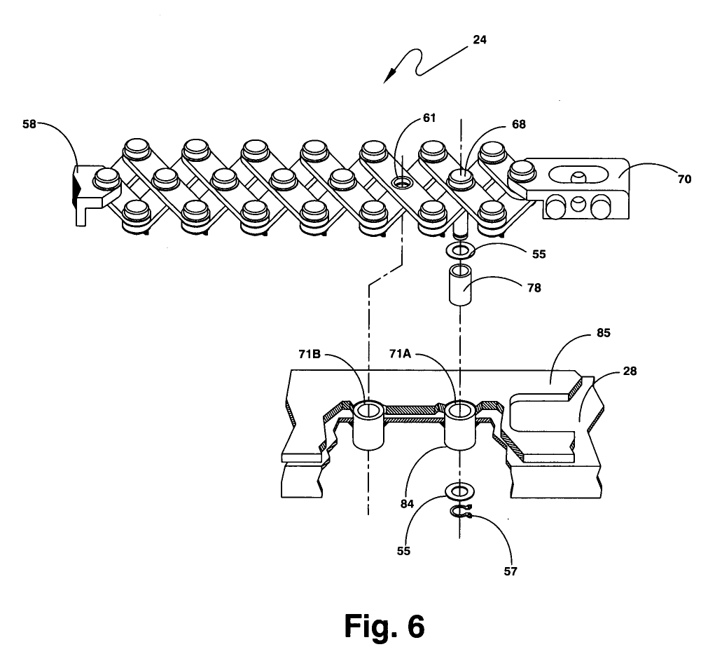

For proper comprehension of rocker pedal position in relation to telescoping apparatus and their interaction during use of scooter it is important to show the views of scooter elements at various stages of use and their subsequent application. Therefore the front elevation of view as shown on FIG. 1 is an embodiment of present invention showing the reciprocating pedal fully extended upwardly with telescoping apparatus 24 compelled into a fully extended position. Retrospectively steering column 22 connects to fork assembly 24 on bottom end and handle bar 20 on top end. Chassis 28 is pivotally connected to fork assembly 24 with mounted front wheel 26 at its pivot point 24A at forward end of chassis 28. Pivot point 24A enables scooter to be steered in various directions by turning handle bar 20. Platform of chassis 28 has mounted on top wear plate 85 along centerline in horizontal plane of chassis 28. Plurality of pivot bracket 60 is rigidly attached to side of chassis opposing each other in alignment along centerline of pivot hole in horizontal plane. Plurality of pivot bracket 60 mounts rocker pedal pivot shaft 38, which is the fulcrum point for parting forward rocker pedal 34 and rear rocker pedal 42 in approximation immediately below hinged connection of forward rocker pedal 34 with rear rocker pedal 42. Forward rocker pedal 34 is attached to support plate 41—not shown—that is permanently attached on both sides to plurality of forward support bracket 47. Support plate 41—not shown—is fastened on its underside to rocker bracket 12. Rocker bracket 12 is straddled between plurality of pivot bracket 60 and pivotally mounted with rocker pedal pivot shaft 38. Rear rocker pedal 42 is attached to support plate 41—not shown—that is connected and permanently attached on both sides to plurality of rear pedal support bracket 40. Plurality of rear pedal support bracket 40 is mounted with rear pivot shaft 43 together with plurality of forward support bracket 47. At distal end of forward rocker pedal 34 is fastened to underside mounting bracket 30 with pivot shaft 17 in pivotal type attachment connecting end piece 11. Upper end of connecting rod 74 is threaded into connecting end piece 11. Downwardly opposite end connecting rod 74 is inserted into extender coupling tube 32 that has indent holes for indent ball assembled into connecting rod 74—not shown. Upper end of connecting rod 72 has assembled indent ball and inserts into downwardly end of extender coupling tube 32 with matching holes for indent ball to lock connecting rod 72 and retrospectively connecting rod 74 into position. This arrangement is intended to enable rocker pedal 34 to reciprocate at various stroke length depending on the chosen position of matching indent balls to holes in coupling tube 32. Distal end of connecting rod 72 is threaded into pivot end piece 76 that inserts into guide slot straddled by shuttle body 70. Pivot shaft 27 provides pivotal arrangement with end piece 76 and shuttle body 70 in vertical plane. Shuttle body 70 inserts into recess of wear plate 85 and has mounted in vertical plane on either side plurality of cam follower 25. Front end of shuttle body 70 has a hole, which has pivotally assembled end pivot shaft 51 in vertical plane with plurality of end lever piece 79. Rear end of shuttle body 70 has threaded into it retainer shaft 39 penetrating retainer bracket 31 in horizontal plane and with compression spring 37 and termination at distal end with threaded adjustment nut 29 with washer 77 sandwiched in between end of compression spring 37 and adjustment nut 29. End portion of retainer shaft 39 is threaded along half way from distal end in approximation. Plurality of end lever piece 79 pivotally connects in vertical plane to plurality of center lever piece 36 with plurality of pivot shaft 53. Opposite end of center lever piece 36 and pivot shaft 53 is pivotally connected in vertical plane to plurality of end lever piece 79. Plurality of end lever piece 79 is pivotally attached in vertical plane to plurality of connecting end pivot shaft 51, which adapts pivotally to through hole in vertical plane of pull shuttle body 58. On one side of pull shuttle body 58 is pivotally mounted connecting lever 52 with pivot shaft 80 in horizontal plane. Bottom part of connecting lever 52 protrudes through of recess 65 and is connected to return cable 56 of return cable 56 is tensioned with of idler pulley 64, which is mounted on tensioner 10 with idler shaft 49. Plurality of return cable 56 is spliced to drive chain 54 with connecting piece 62. Tensioner 10 slides on bracket 66, which is permanently attached to under side of chassis 28 and is adjusted by take up screw 35 and with lock nut 48. Drive chain 54 is aligned by of idler pulley 44 that is mounted on idler support bracket 82 with idler pulley shaft 33. Idler support bracket 82 is permanently attached to topside of chassis 28. Drive chain 54 turns plurality of drive sprocket gear 50 and ratchet mechanism 83—not shown. Drive sprocket gear 50 and ratchet mechanism 83—not shown—and rear traction wheel 46 is mounted on drive shaft 59 provided with key lock—not shown. As referenced in FIG. 6 fulcrum shaft 68 is retaining telescope apparatus 24 immediately above wear strip 85 in a horizontal plane along centerline common to chassis 28 and telescoping apparatus 24.

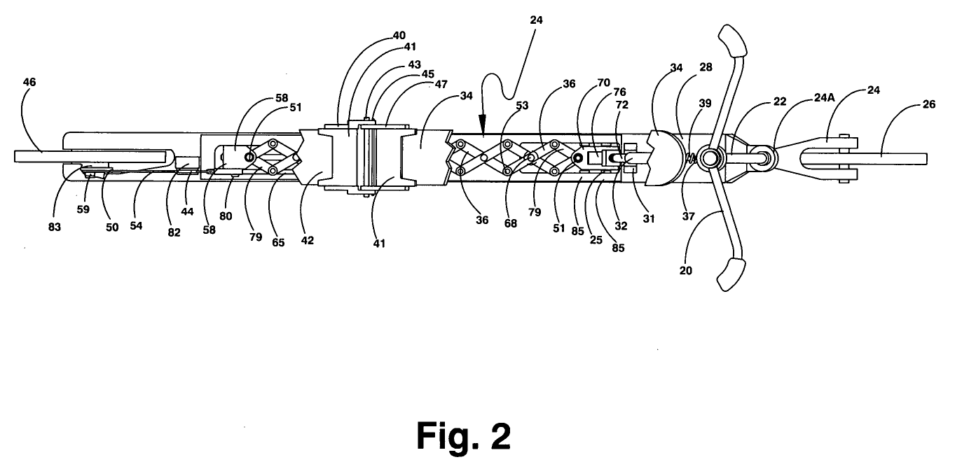

For proper comprehension of rocker pedal position in relation to telescoping apparatus and their interaction during use of scooter it is important to show the views of scooter elements at various stages of use and their subsequent application. Therefore the front elevation of view as shown on FIG. 2 is an embodiment of present invention showing the reciprocating pedal fully extended upwardly with telescoping apparatus 24 compelled into a fully extended position. Retrospectively steering column 22 connects to fork assembly 24 on bottom end and handle bar 20 on top end. Chassis 28 is pivotally connected to fork assembly 24 with mounted front wheel 26 at its pivot point 24A at forward end of chassis 28. Pivot point 24A enables scooter to be steered in various directions by turning handle bar 20. Platform of chassis 28 has mounted on top wear plate 85 along centerline in horizontal plane of chassis 28. Plurality of pivot bracket 60—not shown—mounts rocker pedal pivot shaft 38—not shown, which is the fulcrum point for parting forward rocker pedal 34 and rear rocker pedal 42 in approximation immediately below hinged connection of forward rocker pedal 34 with rear rocker pedal 42. Forward rocker pedal 34 is attached to support plate 41 that is permanently attached on both sides to plurality of forward support bracket 47. Support plate 41 is fastened on its underside to rocker bracket 12—not shown. Rear rocker pedal 42 is attached to support plate 41 that is connected and permanently attached on both sides to plurality of rear pedal support bracket 40. Plurality of rear pedal support bracket 40 is mounted with rear pivot shaft 43 together with plurality of forward support bracket 47. Upper end of connecting rod 74 is threaded into connecting end piece 11—not shown. Downwardly opposite end connecting rod 74—not shown—is inserted into extender coupling tube 32 that has indent holes for indent ball assembled into connecting rod 74—not shown. Distal end of connecting rod 72 is threaded into pivot end piece 76 that inserts into guide slot straddled by shuttle body 70. Shuttle body 70 inserts into recess of wear plate 85 and has mounted in vertical plane on either side plurality of cam follower 25. Front end of shuttle body 70 has a hole, which has pivotally assembled end pivot shaft 51 in vertical plane with plurality of end lever piece 79. Rear end of shuttle body 70 has threaded into it retainer shaft 39 penetrating retainer bracket 31 in horizontal plane and with compression spring 37. End portion of retainer shaft 39 is threaded along half way from distal end in approximation. Plurality of end lever piece 79 pivotally connects in vertical plane to plurality of center lever piece 36 with plurality of pivot shaft 53. Opposite end of plurality of center lever piece 36 and plurality of pivot shaft 53 is pivotally connected in vertical plane to plurality of end lever piece 79. Plurality of end lever piece 79 is pivotally attached in vertical plane to plurality of connecting end pivot shaft 51, which adapts pivotally to through hole in vertical plane of pull shuttle body 58. On side of pull shuttle body 58 is pivotally mounted connecting lever 52 with pivot shaft 80 in horizontal plane. Bottom part of connecting lever 52 protrudes through recess 65 and is connected to return cable 56. Return cable 56 is tensioned with idler pulley 64, which is mounted on tensioner 10 with idler shaft 49. Return cable 56 is spliced to drive chain 54 with connecting piece 62. Tensioner 10 slides on bracket 66, which are permanently attached to under side of chassis 28 and are adjusted by, take up screw 35 and with lock nut 48. Drive chain 54 is aligned by idler pulley 44 that is mounted on idler support bracket 82 with idler pulley shaft 33. Idler support bracket 82 is permanently attached to topside of chassis 28. Drive chain 54 turns plurality of drive sprocket gear 50 and ratchet mechanism 83—not shown. Drive sprocket gear 50 and ratchet mechanism 83—not shown—and rear traction wheel 46 is mounted on drive shaft 59 provided with key lock—not shown. As referenced in FIG. 6 fulcrum shaft 68 is retaining telescope apparatus 24 immediately above wear strip 85 in a horizontal plane along centerline common to chassis 28 and telescoping apparatus 24.

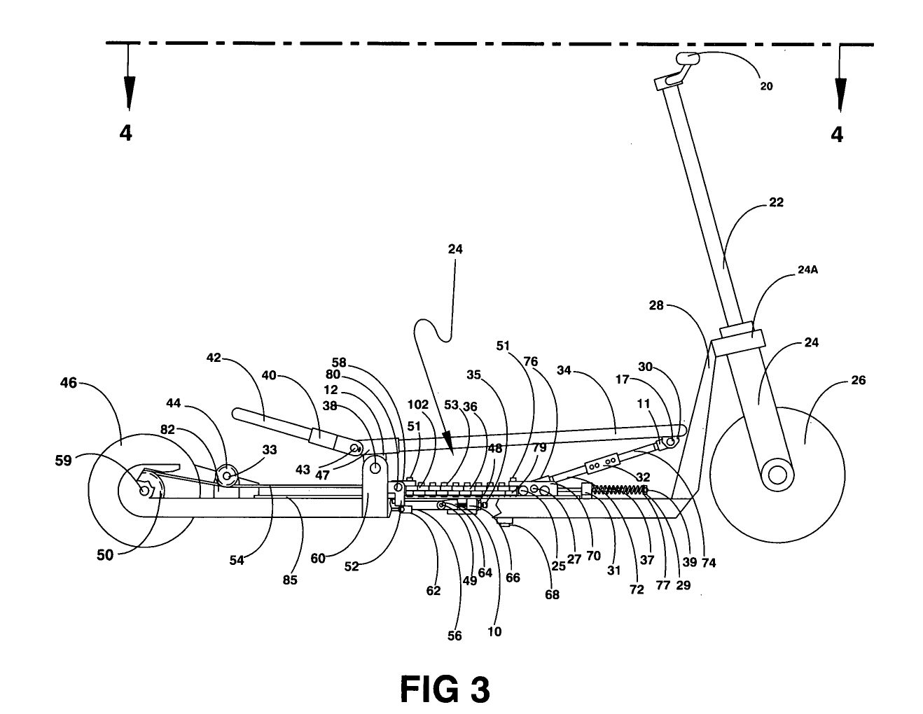

It is noteworthy to mention that the application of a telescoping apparatus as an element for propulsion of a scooter is of great advantage as it is demonstrated on FIG. 3 showing a side elevation of an embodiment of present invention showing the reciprocating pedal rear portion 42 and forward rocker pedal 34 in a in downward position and showing telescoping apparatus 24 compelled into a fully contracted position. It is to recognize that a small incremental horizontal movement of shuttle 70 towards fulcrum shaft 68 compels a large incremental movement of pull shuttle 58 also towards fulcrum shaft 68 although in opposite direction therefore displacing chain 54 along drive pulley 50 causing traction wheel 46 to turn many revolutions in a clock wise direction. Retrospectively steering column 22 connects to fork assembly 24 on bottom end and handle bar 20 on top end. Chassis 28 is pivotally connected to fork assembly 24 with mounted front wheel 26 at its pivot point 24A at forward end of chassis 28. Pivot point 24A enables scooter to be steered in various directions by turning handle bar 20. Platform of chassis 28 has mounted on top wear plate 85 along centerline in horizontal plane of chassis 28. Plurality of pivot bracket 60 is rigidly attached to side of chassis 28 opposing each other in alignment along centerline of pivot hole in horizontal plane. Plurality of pivot bracket 60 mounts rocker pedal pivot shaft 38, which is the fulcrum point for parting forward rocker pedal 34 and rear rocker pedal 42 in approximation immediately below hinged connection of forward rocker pedal 34 with rear rocker pedal 42. Forward rocker pedal 34 is attached to support plate 41—not shown—that is permanently attached on both sides to plurality of forward support bracket 47. Support plate 41—not shown—is fastened on its underside to rocker bracket 12. Rocker bracket 12 is straddled between plurality of pivot bracket 60 and pivotally mounted with rocker pedal pivot shaft 38. Rear rocker pedal 42 is attached to support plate 41—not shown—that is connected and permanently attached on both sides to plurality of rear pedal support bracket 40. Plurality of rear pedal support bracket 40 is mounted with rear pivot shaft 43 together with plurality of forward support bracket 47. At distal end of forward rocker pedal 34 is fastened to underside mounting bracket 30 with pivot shaft 17 in pivotal type attachment connecting end piece 11. Upper end of connecting rod 74 is threaded into connecting end piece 11. Downwardly opposite end connecting rod 74 is inserted into extender coupling tube 32 that has indent holes for indent ball assembled into connecting rod 74—not shown. Upper end of connecting rod 72 has assembled indent ball—not shown—and inserts into downwardly end of extender coupling tube with matching plurality of hole for indent ball to lock connecting rod 72 and retrospectively connecting rod 74 into position. This arrangement is intended to enable rocker pedal 34 to reciprocate at various stroke length depending on the chosen position of matching indent ball to hole in coupling tube 32. Distal end of connecting rod 72 is threaded into pivot end piece 76 that inserts into guide slot straddled by shuttle body 70. Pivot shaft 27 provides pivotal arrangement with end piece 76 and shuttle body 70 in vertical plane. Shuttle body 70 inserts into recess of wear plate 85 and has mounted in vertical plane on either side plurality of cam follower 25. Front end of shuttle body 70 has a hole, which has pivotally assembled end pivot shaft 51 in vertical plane with plurality of end lever piece 79. Rear end of shuttle body 70 has threaded into it retainer shaft 39 penetrating retainer bracket 31 in horizontal plane and with compression spring 37 and termination at distal end with threaded adjustment nut 29 with washer 77 sandwiched in between end of compression spring 37 and adjustment nut 29. End portion of retainer shaft 39 is threaded along half way from distal end in approximation. Plurality of end lever piece 79 pivotally connects in vertical plane to plurality of center lever piece 36 with plurality of pivot shaft 53. Opposite end of plurality of center lever piece 36 and plurality of pivot shaft 53 is pivotally connected in vertical plane to plurality of end lever piece 79. Plurality of end lever piece 79 is pivotally attached in vertical plane to plurality of connecting end pivot shaft 51, which adapts pivotally to through hole in vertical plane of pull shuttle body 58. On one side of pull shuttle body 58 is pivotally mounted connecting lever 52 with pivot shaft 80 in horizontal plane. Bottom part of connecting lever 52 protrudes through recess 65 and is connected to return cable 56. Return cable 56 is tensioned with idler pulley 64, which is mounted on tensioner 10 with idler shaft 49. Return cable 56 is spliced to drive chain 54 with connecting piece 62. Tensioner 10 slides on bracket 66, which are permanently attached to under side of chassis 28 and are adjusted by, take up screw 35 and with lock nut 48. Drive chain 54 is aligned by of idler pulley 44 that is mounted on idler support bracket 82 with idler pulley shaft 33. Idler support bracket 82 is permanently attached to topside of chassis 28. Drive chain 54 turns plurality of drive sprocket gear 50 and ratchet mechanism 83—not shown. Drive sprocket gear 50 and ratchet mechanism 83—not shown—and rear traction wheel 46 is mounted on drive shaft 59 provided with key lock—not shown. As referenced in FIG. 6 fulcrum shaft 68 is retaining telescope apparatus 24 immediately above wear strip 85 in a horizontal plane along centerline common to chassis 28 and telescoping apparatus 24.

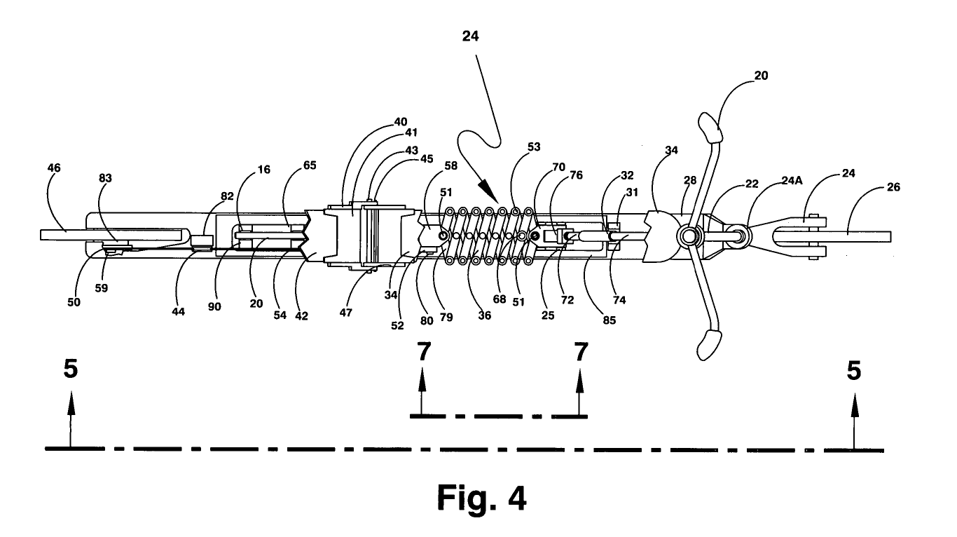

FIG. 4 is showing a side view elevation of an embodiment of present invention showing the reciprocating pedal rear portion 42 and forward rocker pedal 34 in a in downward position and showing telescoping apparatus 24 compelled into a fully contracted position. Retrospectively steering column 22 connects to fork assembly 24 on bottom end and handle bar 20 on top end. Chassis 28 is pivotally connected to fork assembly 24 with mounted front wheel 26 at its pivot point 24A at forward end of chassis 28. Pivot point 24A enables scooter to be steered in various directions by turning handle bar 20. Platform of chassis 28 has mounted on top wear plate 85 along centerline in horizontal plane of chassis 28. Plurality of pivot bracket 60 is rigidly attached to side of chassis opposing each other in alignment along centerline of pivot hole in horizontal plane. Plurality of pivot bracket 60—not shown—mounts rocker pedal pivot shaft 38—not shown—, which is the fulcrum point for parting forward rocker pedal 34 and rear rocker pedal 42 in approximation immediately below hinged connection of forward rocker pedal 34 with rear rocker pedal 42. Forward rocker pedal 34 is attached to support plate 41 that is permanently attached on both sides to plurality of forward support bracket 47. Support plate 41 is fastened on its underside to rocker bracket 12—not shown. Rear rocker pedal 42 is attached to support plate 41 that is connected and permanently attached on both sides to plurality of rear pedal support bracket 40. Plurality of rear pedal support bracket 40 is mounted with rear pivot shaft 43 together with plurality of forward support bracket 47. At distal end of forward rocker pedal 34 is fastened to underside mounting bracket 30—not shown—with pivot shaft 17—not shown—in pivotal type attachment connecting end piece 11—not shown. Upper end of connecting rod 74 is threaded into connecting end piece 11—not shown. Downwardly connecting rod 74 is inserted into extender coupling tube 32 that has plurality of indent hole for indent ball assembled into connecting rod 74—not shown. Upper end of connecting rod 72 has assembled indent ball—not shown—and inserts into downwardly end of extender coupling tube with matching hole for indent ball to lock connecting rod 72 and retrospectively connecting rod 74 into position. This arrangement is intended to enable rocker pedal 34 to reciprocate at various stroke length depending on the chosen position of matching indent ball to hole in coupling tube 32. Distal end of connecting rod 72 is threaded into pivot end piece 76 that inserts into guide slot straddled by shuttle body 70. Pivot shaft 27 provides pivotal arrangement with end piece 76 and shuttle body 70 in vertical plane. Shuttle body 70 inserts into recess of wear plate 85 and has mounted in vertical plane on either side plurality of cam follower 25. Front end of shuttle body 70 has a hole, which has pivotally assembled end pivot shaft 51 in vertical plane with plurality of end lever piece 79. Plurality of end lever piece 79 pivotally connects in vertical plane to plurality of center lever piece 36 with plurality of pivot shaft 53. Opposite end of plurality of center lever piece 36 and plurality of pivot shaft 53 is pivotally connected in vertical plane to plurality of end lever piece 79. Plurality of end lever piece 79 is pivotally attached in vertical plane to plurality of connecting end pivot shaft 51, which adapts pivotally to through hole in vertical plane of pull shuttle body 58. On one side of pull shuttle body 58 is pivotally mounted connecting lever 52 with pivot shaft 80 in horizontal plane. Bottom part of connecting lever 52 protrudes through recess 65 and is connected to return cable 56. Return cable 56 is tensioned with idler pulley 64, which is mounted on tensioned 10 with idler shaft 49. Return cable 56 is spliced to drive chain 54 with connecting piece 62. Drive chain 54 is aligned by of idler pulley 44 that is mounted on idler support bracket 82 with idler pulley shaft 33. Idler support bracket 82 is permanently attached to topside of chassis 28. Drive chain 54 turns plurality of drive sprocket gear 50 and ratchet mechanism 83—not shown. Drive sprocket gear 50 and ratchet mechanism 83—not shown—and rear traction wheel 46 is mounted on drive shaft 59 provided with key lock—not shown. As referenced in FIG. 6 fulcrum shaft 68 is retaining telescope apparatus 24 immediately above wear strip 85 in a horizontal plane along centerline common to chassis 28 and telescoping apparatus 24.

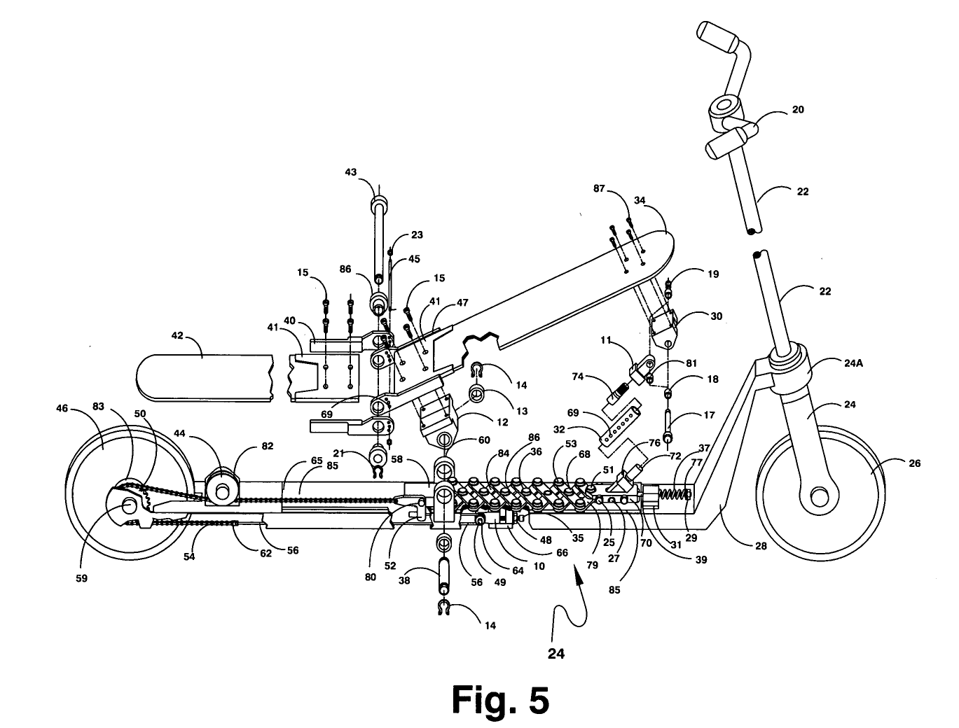

FIG. 5 shows an exploded and perspective view of an embodiment of present invention. Steering column 22 connects to fork assembly 24 on bottom end and handle bar 20 on top end. Chassis 28 is rigidly connected to fork assembly 24 with mounted front wheel 26 at its pivot point 24A. Pivot point 24A enables scooter to be steered in various directions by turning handle bar 20. Platform of chassis 28 has mounted on top of it wear plate 85 along longitudinal centerline in horizontal plane of chassis 28. On side of chassis 28 is plurality of pivot bracket 60 permanently attached? Plurality of pivot bracket 60 mounts rocker pedal pivot shaft 38, which is the fulcrum point for forward rocker pedal 34. Forward rocker pedal 34 is fastened to support plate 41 with plurality of screw 15 that is permanently attached on both sides to plurality of forward support bracket 47. Support plate 41 is fastened on its underside to rocker bracket 12 with plurality of screw 15. Rocker bracket 12 is mounted in between plurality of pivot bracket 60 with rocker pedal pivot shaft 38. Rocker pedal pivot shaft 38 fits together with plurality of bearing bushing 13, which are a press fit in hole of rocker bracket 12 and a slip fit with rocker pedal pivot shaft 38. Retainer clip 14 on either end of rocker pedal pivot shaft 38 is holding same in permanent position. Rear rocker pedal 42 is fastened to support plate 41 with plurality of screw 15 that is connected permanently attached on both sides to plurality of rear pedal support bracket 40. Plurality of rear pedal support bracket 40 is assembled with plurality of forward support bracket 47 and plurality of retainer bushing 20 press fit mounted into hole of plurality of rear pedal support bracket 40 and 47 and slip fit mounted over rear pivot shaft 43. Retainer clip 21 is retaining assembled rear pivot shaft 43 in position. Angularity of rear pedal in relation to angular position of front forward rocker pedal 34 can be adjusted to various angles desired by alignment of plurality of adjustment hole 67 to match hole position with plurality of rear pedal support bracket 40 and forward support bracket 47 retrospectively and inserting adjustment shaft 45 with nut 23 locking into new position threaded on opposite ends against bracket 40 and 47 retrospectively. The angle change increments are limited to plurality of adjustment hole 67 and plurality of rear pedal support bracket 40 and forward support bracket 47. Upper end of connecting rod 74 is threaded into connecting end piece 11. Downwardly opposite end connecting rod 74 is inserted into extender coupling tube 32 that has plurality of indent hole 69 for indent ball assembled into connecting rod 74—not shown. Upper end of connecting rod 72 has assembled indent ball and inserts into downwardly end of extender coupling tube 32 with matching holes for indent ball to lock connecting rod 72 and retrospectively connecting rod 74 into position. This arrangement is intended to enable rocker pedal 34 to reciprocate at various stroke length depending on the chosen position of matching indent ball to hole in coupling tube 32. Distal end of connecting rod 72 is threaded into pivot end piece 76 that inserts into guide slot straddled by shuttle body 70. Pivot shaft 27 provides pivotal arrangement with end piece 76 and shuttle body 70 in vertical plane. Shuttle body 70 inserts into recess of wear plate 85 and have mounted in vertical plane on either side plurality of cam follower 25. Front end of shuttle body 70 has a hole, which has pivotally assembled end pivot shaft 51 in vertical plane with plurality of end lever piece 79. Rear end of shuttle body 70 has threaded into it retainer shaft 39 penetrating retainer bracket 31 in horizontal plane and with compression spring 37 and termination at distal end with threaded adjustment nut 29 with washer 77 sandwiched in between end of compression spring 37 and adjustment nut 29. End portion of retainer shaft 39 is threaded along half way from distal end in approximation. Plurality of end lever piece 79 pivotally connects in vertical plane to plurality of center lever piece 36 with plurality of pivot shaft 53. Opposite end of center lever piece 36 and pivot shaft 53 is pivotally connected in vertical plane to plurality of end lever piece 79. Plurality of end lever piece 79 is pivotally attached in vertical plane to plurality of connecting end pivot shaft 51, which adapts pivotally to through hole in vertical plane of pull shuttle body 58. On one side of pull shuttle body 58 is pivotally mounted connecting lever 52 with pivot shaft 80 in horizontal plane. Bottom part of connecting lever 52 protrudes through of recess 65 and is connected to return cable 56 of return cable 56 is tensioned with of idler pulley 64, which is mounted on tensioner 10 with idler shaft 49. Plurality of return cable 56 is spliced to drive chain 54 with connecting piece 62—not shown. Tensioner 10 slides on bracket 66, which is permanently attached to under side of chassis 28 and is adjusted by take up screw 35 and with lock nut 48. Drive chain 54 is aligned by of idler pulley 44 that is mounted on idler support bracket 82 with idler pulley shaft 33. Idler support bracket 82 is permanently attached to topside of chassis 28. Drive chain 54 turns plurality of drive sprocket gear 50 and ratchet mechanism 83—not shown. Drive sprocket gear 50 and ratchet mechanism 83—not shown—and rear traction wheel 46 is mounted on drive shaft 59 provided with key lock—not shown. As referenced in FIG. 6 fulcrum shaft 68 is retaining telescope apparatus 24 immediately above wear strip 85 in a horizontal plane along centerline common to chassis 28 and telescoping apparatus 24.

The lateral expansion and subsequent retraction in distance of a lever type telescope apparatus is entirely dependent on the number of links assembled to make an array and the fulcrum point chosen in distance from the end point of assembled array. Therefore as further away in distance the end point connected to a shuttle apparatus is from the fulcrum point as longer of a distance the shuttle apparatus must travel to complete a full retraction of the telescoping apparatus. Retrospectively the opposite of aforesaid applies for as shorter in distance the end point connected to a shuttle apparatus is from the fulcrum point as shorter of a distance the shuttle apparatus must travel to complete a full retraction of the telescoping apparatus. Therefore the forward motion of a scooter propelled by a telescoping apparatus can be controlled in propulsive speed and torque by the ratio of the opposing ends traveling to and from each other in distance and speed dependent on the stationary fulcrum point chosen along the horizontal center axis of array. FIG. 6 shows an exploded and perspective view of an embodiment of present invention with partial cut away feature. Liner bushing 78 presses fits into plurality of fulcrum adapter 84 with bearing washer 55 sandwiched between bottom side of telescoping apparatus 24 and topside of fulcrum adapter 84. Plurality of fulcrum adapter 84 is permanently attached to under side of chassis 28 with a clearance through hole through wear plate 85. Telescoping apparatus 24 with fulcrum shaft 68 adapts through liner bushing 78 and clearance fits plurality of bearing washer 55. Retainer clip 57 retains fulcrum shaft 68 in position 71A. Secondary position 71B and 61 retrospectively and fulcrum adapter 84 provide a change in ratio of shuttle 70 in travel length along longitudinal center line of telescoping apparatus 24 in relation to opposing pull shuttle body 58 reducing the maximum travel length by one half.

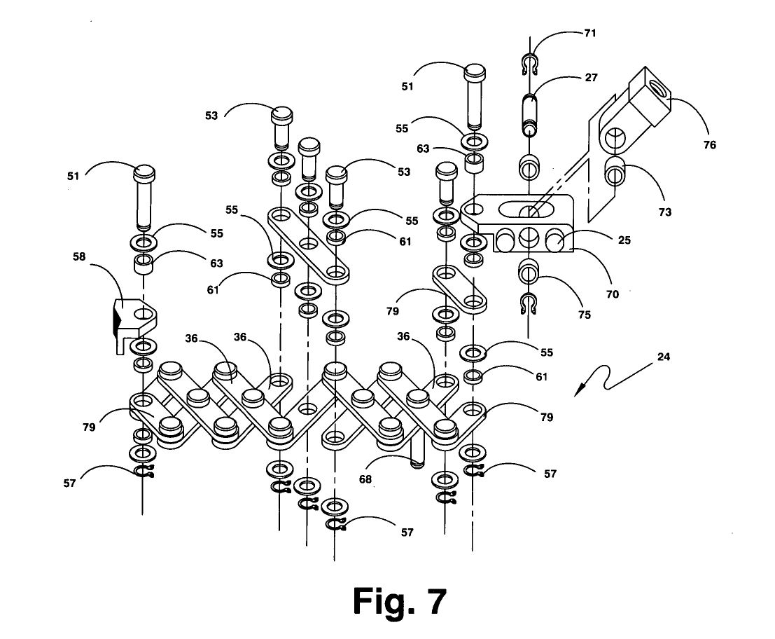

Lever type telescoping apparatus are easily obtainable and available in many different configurations. Therefore it is note worthy to mention that the construction of such a telescoping apparatus must be carefully conceived to be of good use and of proper application as a key element to enable a scooter to be propelled forward without foot engagement of scooter passenger with the ground surface. FIG. 7 shows an exploded and perspective view of an embodiment of present invention. Shuttle body 70 with plurality of cam follower 25 attached accommodates pivot end piece 76 with press fit bushing 73 assembled into pivot hole. Plurality of press fit bushing 75 is assembled into pivot holes of shuttle body 70. Thus when pivot end piece 76 is being lined up with its pivot hole and the pivot hole of shuttle body 70 pivot shaft 27 will slip fit through plurality of bushing 75 and bushing 73 and be retained in proper position by spring clip 71 on either end of pivot shaft 27. Bushing 63 press fit assembles into nose end pivot hole of shuttle body 70. Plurality of bushing 61 press fit assemblies into pivot hole of plurality of end lever piece 79. Bearing washer 55 separates surface of shoulder of end pivot shaft 51 to topside of shuttle body 70. Bearing washer 55 separates bottom side of shuttle body 70 to topside of end lever piece 79. Bearing washer 55 separates bottom side to topside of plurality of end piece lever. Bearing washer 55 separates bottom side of end piece lever 79 and retainer clip 57. End pivot shaft 51 slip fits through bushing 63, plurality of bushing 61 and clearance fits through plurality of bearing washer 55. Retainer clip 57 will retain end pivot shaft 51 in its proper position. Plurality of bushing 55 press fit assembles into plurality of center lever piece 36. Shoulder of plurality of center pivot shaft 53 to topside of plurality of center lever piece 36 is separated by plurality of bearing washer 55. Bottom side of plurality of center lever piece 36 to topside of plurality of center lever piece is separated by plurality of bearing washer 55. Bottom side of plurality of center lever piece 36 is separated from plurality of retainer clip 57 by plurality of bearing washer 55. Plurality of center pivot shaft 53 slip fits through plurality of bushing 61, and clearance fits through plurality of bearing washer 55. Plurality of retainer clip 57 will retain plurality of end pivot shaft 51 in its proper position. Bushing 63 press fit assembles into nose end pivot hole of pull shuttle body 58. Plurality of bushing 61 press fit assembles into pivot hole of plurality of end lever piece 79. Bearing washer 55 separates surface of shoulder of end pivot shaft 51 to topside of pull shuttle body 58. Bearing washer 55 separates bottom side of shuttle body 70 to topside of end lever piece 79. Bearing washer 55 separates bottom side to topside of plurality of end piece lever 79. Bearing washer 55 separates bottom side of end piece lever 79 and retainer clip 57. End pivot shaft 51 slip fits through bushing 63, plurality of bushing 61 and clearance fits through plurality of bearing washer 55. Retainer clip 57 will retain end pivot shaft 51 in its proper position. Singularity of fulcrum shaft 68 is mounted through center pivot hole of plurality of center lever piece 36

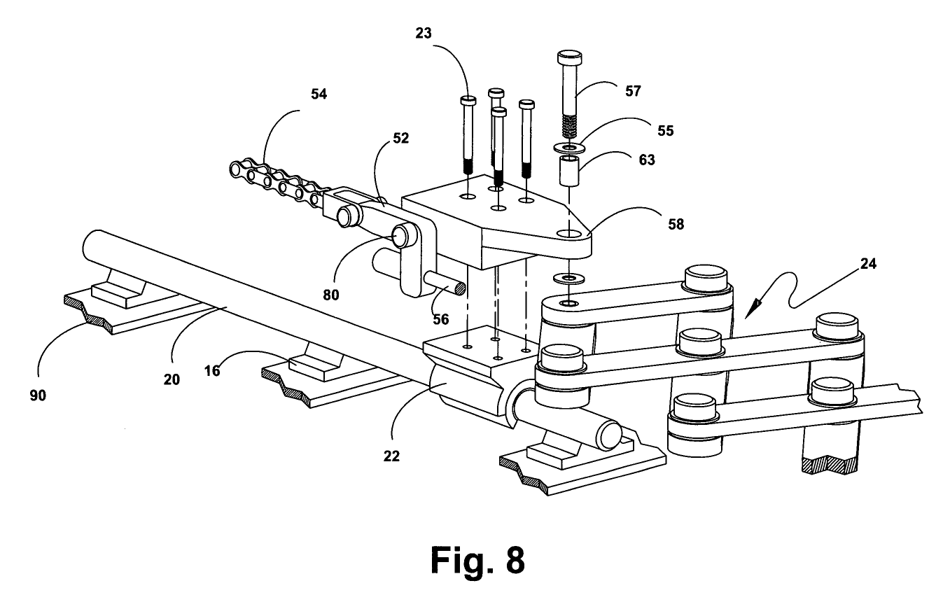

Further consideration has to be given to the proper application of a telescoping apparatus for it to be the key element to enable a scooter to be propelled forward without foot engagement of scooter passenger with ground surface. FIG. 8 is an exploded and perspective view of an embodiment of present invention. Pull shuttle body 58 is fastened atop of mounting face of linear bearing 22 with plurality of fastener 23. Pivot shaft 57 attaches telescoping apparatus 24 in pivotal fashion with bushing 63 and plurality of bearing washer 55 to mounting face of underside of pull shuttle body 58. Connecting lever 52 is pivotal fastened on one side of pull shuttle body 58 by pivot shaft 80 with drive chain 54 pivotal attached to one end and return cable attached to opposing end below pivot shaft 80. Linear bearing 22 travels along longitudinal center line of liner shaft 20 whereby telescoping apparatus 24 remains to be accurately aligned during operation therefore preventing same to be of diminished capability, performance and durability. Liner shaft 20 is rigidly attached to plurality of liner shaft mount 16 that mounts on plurality of chassis cross support 90.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specifications as including more than one meaning, then its use must be understood as being generic to all possible meanings supported by the specifications and by the word or words describing the element.

The definitions of the words or elements of the embodiments of the herein described invention and its related embodiments not described are, therefore, in this specifications to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim. Changes from the claimed subject matter as viewed by a person with ordinary skill in the art, not known or later devised, are expressly contemplated as being equivalents within the scope of the invention and its various embodiments. Therefore, obvious substitutions now or later known to one with ordinary skill in the art defined to be within the scope of the defined elements. The invention and its various embodiments are thus to be understood to include what is specifically illustrated and described above, what is conceptually equivalent, what can obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor believes that the claimed subject matter is the invention.

What is claimed is:

1. A pedal scooter comprising a chassis having a steering front wheel pivotally mounted in a vertical plane at the forward end thereof and a traction wheel mounted in vertical plane at the rear thereof with said chassis supporting a pivotal mounted pedal board with a pivotal link connected to a telescoping apparatus for propelling said scooter, including a drive sprocket gear and a chain loop engaging and extending about said drive sprocket gear with said drive sprocket gear being connected to said traction wheel and said drive chain connected to one end of said telescoping apparatus having a connection piece.

2. The apparatus of claim 1 wherein a ratchet mechanism is included with said drive sprocket in only one rotational direction corresponding to rotation of said traction wheel.

3. The apparatus of claim 2 comprising free wheeling of said traction wheel.

4. The apparatus of claim 1 further comprising said pedal board of forward portion and rear ward portion parted in approximation by a central pivotal support arrangement below a hinged connecting arrangement between said rearward portion and said forward portion of said pedal.

5. The apparatus of claim 1 further comprising at distal end of said pedal board forward section a mounting element with a pivotally connected link in a downwardly direction.

6. The apparatus of claim 1 further comprising a tubular attachment to said pivotal link end having a link extension attached in coaxial fashion to opposite end of said tubular attachment with distal end of said link extension engaging with a pivot end piece straddled by a shuttle mechanism in vertical plane with said shuttle mechanism pivotally connected to end of said telescoping apparatus in a horizontal plane.

7. The apparatus of claim 1 further comprising said telescoping apparatus pivotally mounted in a horizontal plane along longitudinal centerline on upper end of said chassis immediately below said pedal board.

8. The apparatus of claim 1 further comprising said telescoping apparatus end portion pivotally connected in vertical plane to a nose end pull bracket with said nose end pull bracket to be aligned by a linear bearing encircling a linear shaft whereby said linear shaft is mounted to chassis immediately below and along longitudinal center axis of said telescoping apparatus and with said nose end pull bracket having said connection piece slightly off set from longitudinal center line of said telescoping apparatus and pivotally mounted with one end of said connection piece spliced to said drive chain with its opposing end spliced to a cable end.

9. The apparatus of claim 1 further comprising said drive chain to be spliced to return cable to form with said return cable an endless loop with distal end of return cable spliced to said connection piece wherein one section of said endless loop comprises said drive chain encircling and engaging said drive sprocket gear and the other section of said endless loop comprises return cable encircling an idler pulley mounted to under side of said chassis comprising tensioning element for said endless loop.
